(19) United States
(12) Patent Application Publication
(10) Pub. No.: US 2007/0073576 A1
(43) Pub. Date: Mar. 29, 2007

(54) Resource capacity planning

(75) Inventors: Daniel Patrick Connors, Pleasant Valley, NY (US); John Louis Deeb, Tucson, AZ (US); John P. Fasano, Briarcliff Manor, NY (US); Matthew J. Florian, Fort Collins, CO (US); Philip J. Garofolo, Apex, NC (US); Donna Leigh Gresh, Cortlandt Manor, NY (US); David Eric Quinney, Romsey (GB); Ronald Alan Zink, Pittsburgh, PA (US)

Correspondence Address: DILLON & YUDELL LLP, 8911 N. CAPITAL OF TEXAS HWY.,, SUITE 2110, AUSTIN, TX, 78759, US

(73) Assignee: International Business Machines Corp., Armonk, NY (US)

(21) Appl. No.: 11/238,909

(22) Filed: Sep. 29, 2005

(51) Int. Cl. G06F 17/30

(52) U.S. Cl. 705/10

(57) ABSTRACT

An integrated Resource Capacity Planning (RCP) process and tool program is presented. The RCP program includes identifying future labor needs and predicted labor supply. A gap analysis between the predicted future needs and supply is performed. Based on the gap analysis, resource actions are planned and taken to alleviate predicted future labor shortages. The predicted gap analysis is later compared with actual future needs/supply to evaluate the effectiveness of the parameters used in the RCP program. The RCP program is enterprise-independent, thus permitting re-use of data and parameters, and allowing the RCP program to be scalable.

### BACKGROUND OF THE INVENTION

1. Technical Field

The present invention relates in general to the field of computers, and in particular to computers used to plan human resource capacity. Still more particularly, the present invention relates to a method and system that allows a labor provider to predict whether future labor resources will be adequate based on labor needs due to opportunities, offerings, and on-demand needs.

2. Description of the Related Art

In recent years, skilled labor resources, particularly in the information technologies area, have become commodities not unlike software and/or hardware. With the increased use of contractors, subcontractors, offshore outsourcing and other non-traditional methods for obtaining needed labor, a need has developed for managing the demand and supply of such labor, especially future demand/supply.

While an enterprise's internal human resources department may be able to predict and adapt to future needs with some precision, typically these predictions are discipline specific, and the adaptations are rarely accurate. For example, consider an enterprise that uses SAP programmers. That enterprise's human resources department may be able to predict, based on jobs in a pipeline, that another 10 SAP programmers will be needed in six months. However, the adaptation made to obtain these needed SAP programmers is typically little more than planning to call executive recruiters or to place employment advertisements. Adaptations such as providing specialized training to current or prospective employees are rarely implemented due to entrenched business procedures and cost impracticalities.

### SUMMARY OF THE INVENTION

The present invention recognizes the need for an integrated Resource Capacity Planning (RCP) process and tool program. The RCP program includes identifying future labor needs and predicted labor supply. A gap analysis between the predicted future needs and supply is performed. Based on the gap analysis, resource actions are planned and implemented to alleviate predicted future labor shortages. The predicted gap analysis is later compared with actual future needs/supply to evaluate the effectiveness of the parameters used in the RCP program. The RCP program is enterprise-independent, thus permitting re-use of data and parameters, and allowing the RCP program to be scalable.

The above, as well as additional purposes, features, and advantages of the present invention will become apparent in the following detailed written description.

### BRIEF DESCRIPTION OF THE DRAWINGS

The novel features believed characteristic of the invention are set forth in the appended claims. The invention itself, however, as well as a preferred mode of use, further purposes and advantages thereof, will best be understood by reference to the following detailed description of an illustrative embodiment when read in conjunction with the accompanying drawings, where:

FIG. 1 illustrates an overview of a Resource Capacity Planning (RCP) program;

FIG. 2 depicts an overview of a relationship between a process for assessing resource supply and a process for managing resource demand;

FIG. 3a illustrates a pyramid that describes roles of different entities that are affected by the RCP program;

FIG. 3b depicts a Graphical User Interface (GUI) that allows an authorized user to log into the RCP program;

FIGS. 4a-b illustrate GUIs used in filtering and structuring staffing structures using the RCP program;

FIG. 5 is a flow-chart of steps taken in creating a demand plan and administration;

FIG. 6a depicts a flow-chart of steps taken for capacity planning, optimization, and resource planning, tracking and measurement;

FIG. 6b-d illustrate GUIs utilized during the steps depicted in FIG. 6a;

FIG. 7 depicts an exemplary server that can be used in the implementation and/or deployment of the RCP program;

FIG. 8 illustrates an exemplary client computer that can be used at an enterprise-level for implementing the RCP program;

FIGS. 9a-b show a flow-chart of steps taken to deploy software capable of executing the steps shown in FIGS. 5 and 6a;

FIGS. 10a-c show a flow-chart of steps taken to deploy in a Virtual Private Network (VPN) software that is capable of executing the steps shown in FIGS. 5 and 6a;

FIGS. 11a-b show a flow-chart showing steps taken to integrate into an computer system software that is capable of executing the steps shown in FIGS. 5 and 6a; and

FIGS. 12a-b show a flow-chart showing steps taken to execute the steps shown in FIGS. 5 and 6a using an on-demand service provider.

### DETAILED DESCRIPTION OF THE PREFERRED EMBODIMENT

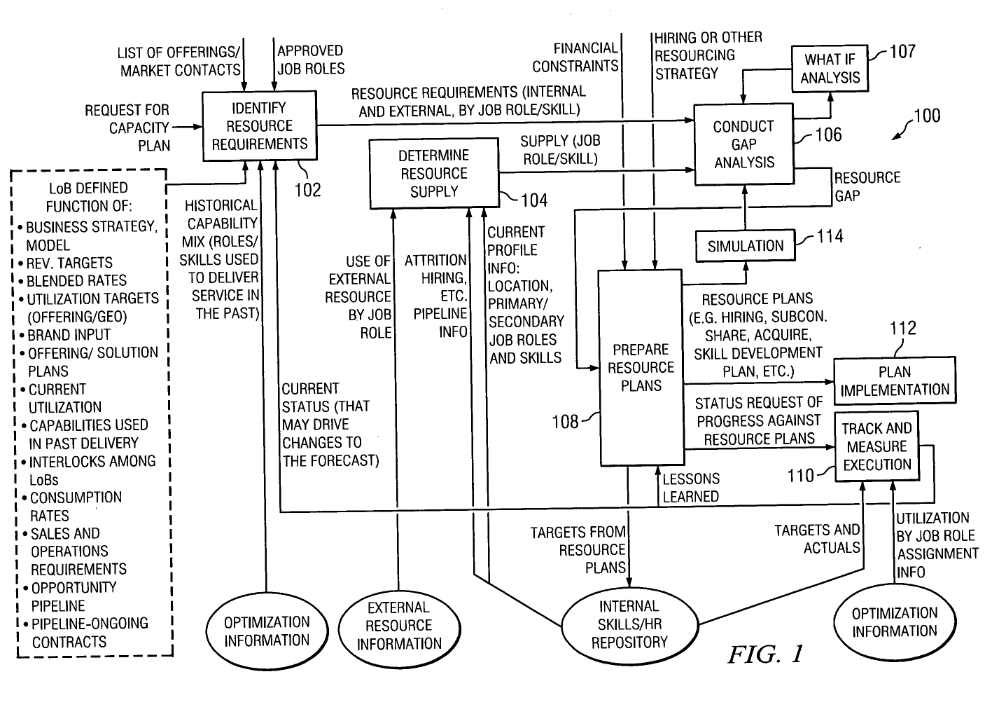

With reference now to the figures, and in particular to FIG. 1, there is depicted a block diagram showing five key processes of a Resource Capacity Planning (RCP) process 100.

A first key process is shown as process 102, (Identify Resource Requirements), in which resource requirements for a job project are identified. Process 102 is preferably performed by a demand administrator, who enters the individual elements of resource demand requirements, including those from ongoing work engagements, prospective work opportunities, and impending work offerings, along with associated staffing structures. Preferably, a demand planner actually creates an overall demand plan, based on demand data generated by process 102. Parameters for construction of a demand statement created by process 102 are preferably provided by line managers.

To determine the resource requirements for a job project, process 102 accepts as inputs a list of offerings/market contracts (impending or pending jobs), approves job roles, a request (for any reason) for a capacity plan, historical capability from past jobs, a current status of results of an evaluation of the present process, as well as enterprise-defined functions for the features, function and requirement of a particular Line of business.

The resulting resource requirements statement from process 102 are then sent to process 106, (Conduct Gap Analysis), which is described in additional detail below.

A second key process is shown as process 104, (Determine Resource Supply), in which a determination of the starting supply level of skilled delivery resources (including workers, hardware and/or software) to be used for comparison against the demand determined in process 102. Preferably, process 104 is performed by a capacity planner to build a supply statement.

Inputs to process 104 include resource information from both internal as well as external resources. These inputs include the use of external resources specified by job role, attrition, hiring, pipeline information, and current profile information for internal resources, including worker profiles, location, job roles and skills, etc. The output of process 104 is a starting supply level statement, which is input into process 106.

A third key process is shown as process 106, (Conduct Gap Analysis), in which a comparison of demand to supply is made throughout a project period. This comparison identifies gaps in the supply of skilled delivery resources (including manpower, hardware, software, etc.). This comparison results in a “starting capacity statement” by which resource plans can be applied to reduce identified gaps between supply and demand. Preferably, process 106 is performed by a capacity planner, who constructs a capacity statement. A line manager, or other business knowledge expert, may provide business parameters to the capacity planner for use in the capacity statement.

As stated above, the resource requirement statement from process 102 and the starting supply level statement from process 104 are input into process 106, which may invoke a “what-if” analysis 107, in which speculative parameters are evaluated to determine different possible supply/demand gaps. Process 106 outputs a “resource gap analysis statement” to process 108.

A fourth key process is shown as process 108, (Prepare Resource Plans), in which mitigation of excesses and shortages in the starting capacity statement is accomplished by specifying resource actions in a tactical time frame to reduce the gaps identified in the starting capacity statement. The output product of process 108 is a “final capacity statement,” which is based on the resource actions applied. Process 108 is performed by a capacity planner, who constructs a resource plan. A line manager views and approves the resource plan to meet the reporting unit's parameters.

Besides the resource gap analysis statement from process 106, process 108 receives inputs in the form of financial constraints, hiring or other resourcing strategy, and “lessons learned” from past generated final capacity statements. Process 108 outputs a “resource plan” (e.g., hiring, subcontractor sharing, resource acquisition, skill development plan (training), etc.) to a plan implementation process 112. This resource plan can also be output to a simulation 114, which creates a simulated implementation of the resource plan, and feeds-back that simulated implementation to process 106.

A fifth key process is shown as process 110, (Track and Measure Execution), which is a supportive process that aids in validating that the data in the overall process is accurate, measures process performance, and improves the decision-making capability of the capacity planner, hence improving the way an enterprise or a third party service provider manages the capacity resources in order to meet their demand.

Inputs to process 110 include a status request of progress against resource plans from process 108, targets and actual skills available both internally and externally, and utilization by job role and assignment data from optimization information.

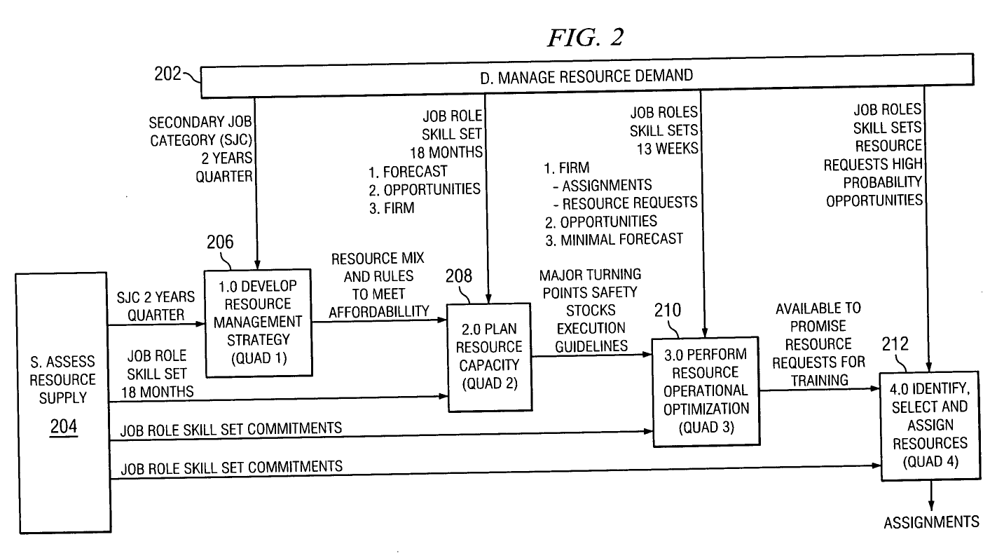

With reference now to FIG. 2, an overview of a relationship between a process 202, for managing resource demand, and a process 204, for assessing resource supply, is shown.

A process 206, (1.0—Develop Resource Management Strategy), preferably performed by a capacity planner, demand planner, and/or demand administrator, develops a resource management strategy, preferably one to three years before the resources (skilled manpower, hardware, software, bandwidth, etc.) will be needed for a particular job. Process 206 is thus performed at an enterprise level, and is slaved to (i.e., comports with) a business strategy (e.g., a three-year plan, mission statement, product/financial goal, etc.) of the enterprise. At process 206, guidelines and rules that govern processes 208-212 are established.

At process 208, (2.0—Plan Resource Capacity), recommendations are made as to how to optimally address projected gaps/gluts between resources and demand for a future project. Preferably, process 208 is performed at a lead time (such as 18 months) before the project begins, in order to allow sourcing channels adequate time to prepare for quick and effective actions when process 208's recommendations are actually triggered in processes 210 and 212.

At process 210, (3.0—Perform Resource Operational Optimization), resource actions are triggered to increase or decrease resource supply, based upon the most recent data and lead times received from process 208 (major turning points, safety stocks, execution guidelines) as well as from process 204 (job role, skill set, commitments).

At process 212, (4.0—Identify, Select & Assign Resources), available resources are assigned to a current job assignment according to resource requests, by applying the actual resource supply to the demand in an optimal manner.

RCP Registration and Data Setup

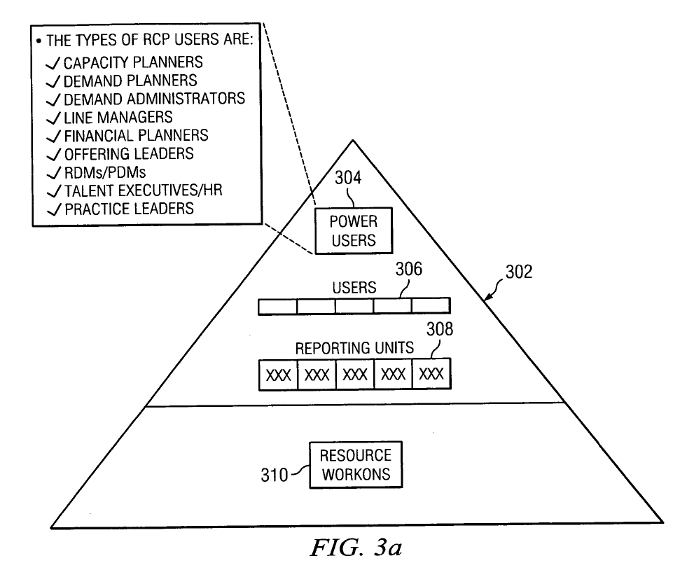

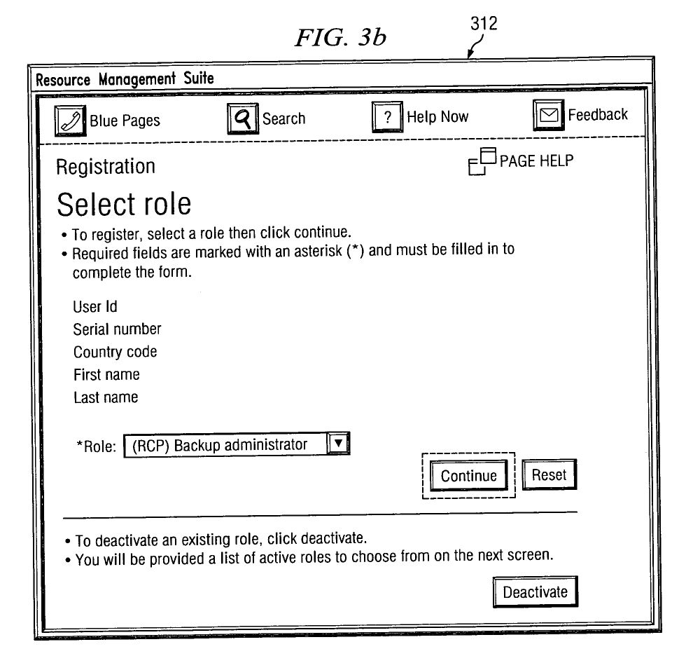

With reference now to FIG. 3a, a high-level diagram of a pyramid 302 describing the roles of different entities according to the presently described process is presented. At the top of pyramid 302 are power users 304, which may be capacity planners, demand planners or demand administrators. The power users 304 influence users 306, which may be Resource Capacity Planning (RCP) administrators (and their backups), capacity planners, demand planners, demand administrators, line managers, financial planners, offering leaders, Remote Deployment Managers (RDMs)/Product Data Managers (PDMs), talent executives (Human Resources) and business practice leaders.

RCP administrators activate and deactivate a user's (skilled worker) role, set up job role information (including blended revenue rate, blended cost rate, and demand measurement units), key common currency information, threshold targets for gap/glut analysis, average costs for resource actions, and set hourly cost rates at a band level.

Demand planners construct a demand plan for a tactical timeframe.

Capacity planners (resource recommenders) create a capacity statement, perform gap analysis functions, resource planning functions, and track and measure functions.

Supporting the users 306 are reporting units 308, which may be enterprise departments, support departments, sub-contractors, etc. Affected by the overall process described herein are all resource workers 310 that may be impacted by the resource capacity planning process described herein.

RCP registration and data setup includes logging into the RCP process. Thus, as shown in FIG. 3b, a GUI 312 allows a power user 304 to log into the RCP process. Additional GUIs (not shown) are then provided to the power user 304 for data setup and periodic maintenance of reference data, including resource action costs, resource cost by band, job role/skill set administration, identifying all authorized RCP users, and key common currency (selected job roles and skill sets to be managed).

Demand Component Administration

To establish a demand statement, the demand component must be created. Details to the demand component are added according to filters set on demand component organizational criteria. Staffing structures are created, and existing component/staffing structures are managed.

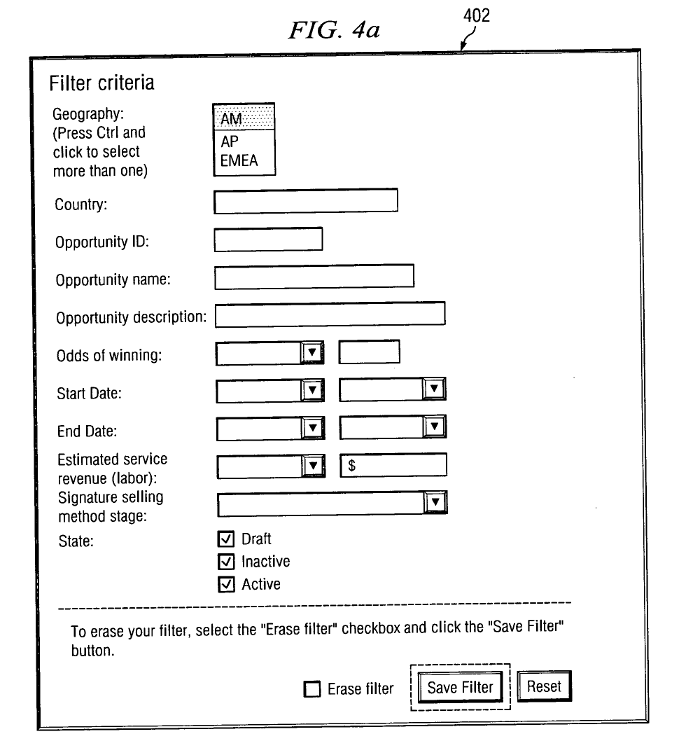

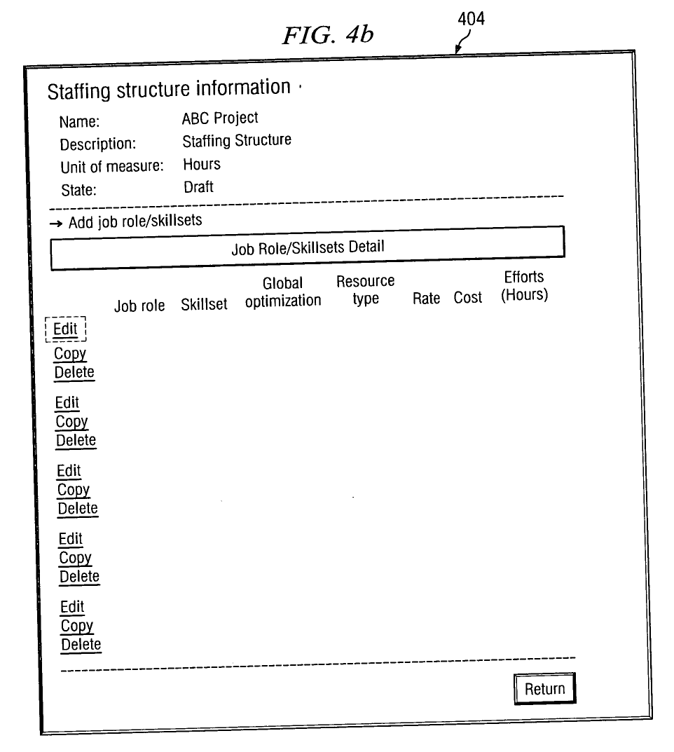

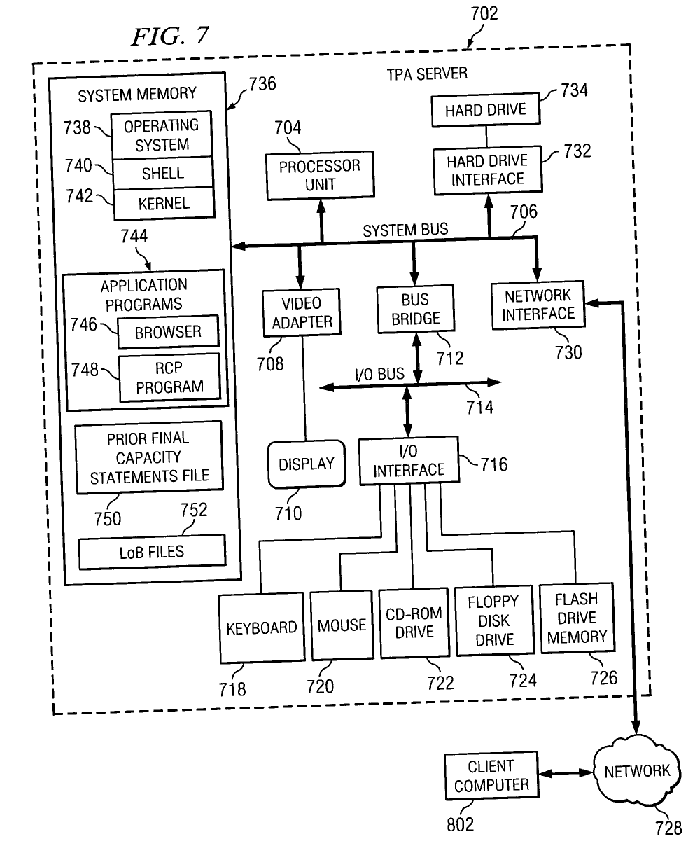

With reference then to FIG. 4a, a GUI 402 is displayed for creating a demand component according to filtered opportunities to create/associate staffing structures. For example, by populating the active windows shown in GUI 402 (i.e., where a future job (opportunity) will be located, the name of the opportunity, the start/end dates, et al.), a GUI 404 (shown in FIG. 4b) will be generated by an RCP program 748 (shown below in FIG. 7) that shows the name of the opportunity and the number of hours that will be needed by each proposed worker.

Demand Plan Administration

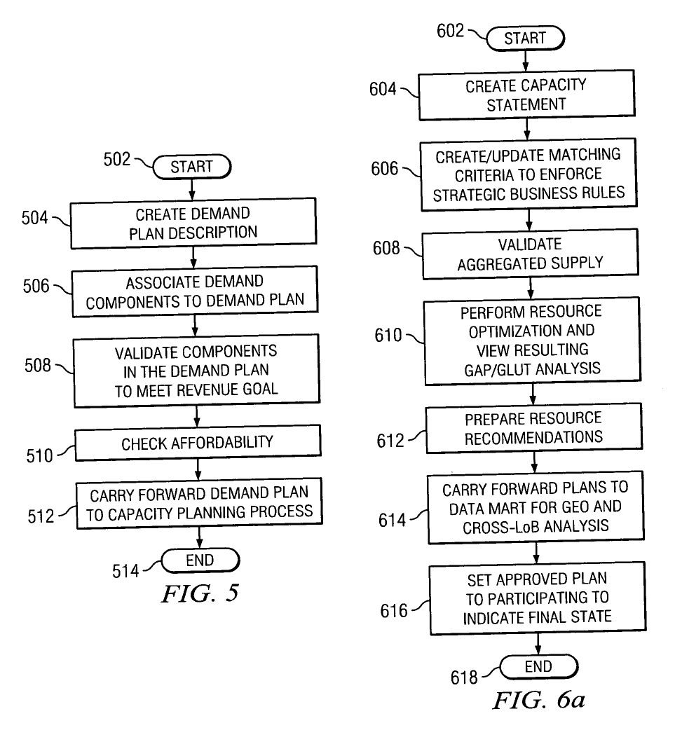

Steps for creating a demand plan and administration are shown in FIG. 5. After initiator block 502, block 504 illustrates creating a demand plan description (including skilled resources needed based on financial targets, opportunities, offerings, business rules, re-used data from other demand plans). At block 506, demand components from the demand plan description are associated with a demand plan. All reporting unit ongoing engagements to be used in the demand plan are associated together, as are opportunities and the reporting unit's offering mix (used to forecast target revenue).

At block 508, components are validated in the demand plan to meet revenue goals. That is, participating revenue should equal target revenue. Similarly, resource demand slated by aggregation of job role/skill set should comport with resource supply.

At block 510, affordability of a proposed job (project) is checked. If the RCP process determines that the project would not be worthwhile financially, then it will be abandoned before an offer (bid) is ever extended to a potential customer.

At block 512, the demand plan is carried forward to the capacity planning process, for use by a current demand plan or by another demand plan having similar parameters. The process ends at terminator block 514.

Capacity and Resource Planning

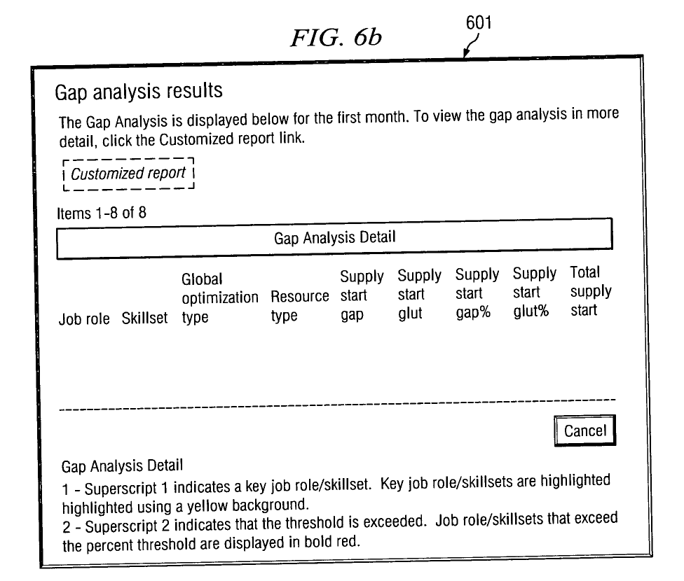

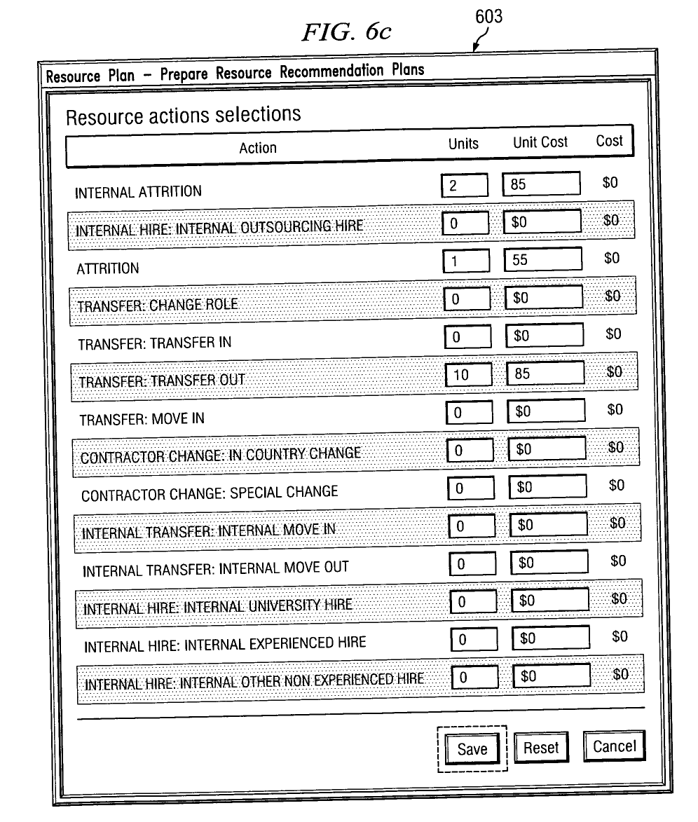

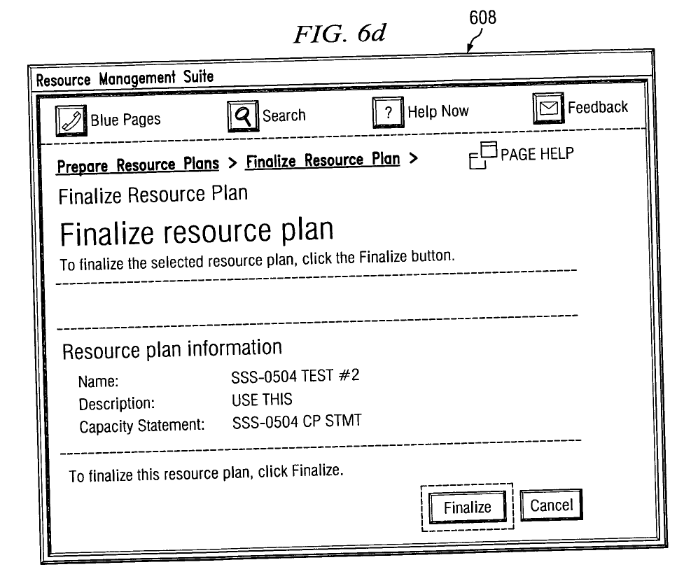

With reference now to FIG. 6a, steps are depicted for capacity planning, optimization, resource planning, tracking and measurement. After initiator block 602, a capacity statement is created (block 604). This capacity statement, as described above, details current and/or projected future resource capacity, including human resources, hardware, software, network bandwidth, etc. Strategic business rules are enforced (block 606), such as deciding what resources to outsource (offshore and/or onshore), derive from internal resources, etc. A total aggregate supply (across an entire enterprise and beyond) is validated as being available now or in the future (block 608), and a gap/glut analysis is performed and viewed (block 610), such as shown in FIG. 6b in a GUI 601.

Based on the viewed gap/glut analysis, resource recommendations are prepared (block 612), including validating job role/skill set recommendations and validating plan costs. Thus, as shown in FIG. 6c, a GUI 603 may be presented showing an administrator different options available to alter worker resource costs/availability.

The finalized plan, as shown in the GUI 605 in FIG. 6d, is then carried forward (block 614) to a central data mart (database), for use by and analysis in other geographic regions and other Lines of Business (Cross-LoB). As described in block 616, upon being approved, the plan is marked (set) as “Participating” to indicate its final state, after which the process ends (terminator block 618).

With reference now to FIG. 7, there is depicted a block diagram of an exemplary Third Party Administrator (service provider) server 702 that can be used to process and/or send to a client computer 802 a RCP program 748, which performed the functions described above. TPA server 702 includes a processor unit 704 coupled to a system bus 706. Also coupled to system bus 706 is a video adapter 708, which drives/supports a display 710. System bus 706 is coupled via a bus bridge 712 to an Input/Output (I/O) bus 714. Coupled to I/O bus 714 is an I/O interface 716, which affords communication with various I/O devices, including a keyboard 718, a mouse 720, a Compact Disk—Read Only Memory (CD-ROM) drive 722, a floppy disk drive 724, and a flash drive memory 726. The format of the ports connected to I/O interface 716 may be any known to those skilled in the art of computer architecture, including but not limited to Universal Serial Bus (USB) ports.

TPA server 702 is able to communicate with a client computer 802 via a network 728 using a network interface 730, which is coupled to system bus 706. Preferably, network 728 is the Internet.

Also coupled to system bus 706 is a hard drive interface 732, which interfaces with a hard drive 734. In a preferred embodiment, hard drive 734 populates a system memory 736, which is also coupled to system bus 706. Data that populates system memory 736 includes TPA server 702's operating system 738, which includes a command interpreter program known as a shell 740, which is incorporated in a higher level operating system layer and utilized for providing transparent user access to resources such as application programs 744, which include a browser 746, a Resource Capacity Planning (RCP) program 748, as well as data files including but not limited to a prior final capacity statements file 750 and Line of Business (LoB) files 752.

As is well known in the art, a command interpreter or “shell” is generally a program that provides an interpreter and interfaces between the user and the operating system. More specifically, a shell program executes commands that are entered into a command line user interface or from a file.

The shell (UNIX) or command processor (Windows) is generally the highest level of the operating system software hierarchy and serves as a command interpreter. The shell typically provides a system prompt, interprets commands entered by keyboard, mouse, or other user input media, and sends the interpreted command(s) to the appropriate lower levels of the operating system (e.g. a kernel 742) for processing.

Exemplary application programs 744 used in the present invention are web browser 746 and RCP program 748. Web browser 746 includes program modules and instructions enabling a World Wide Web (WWW) client (i.e., client computer 802) to send and receive network messages to the Internet using HyperText Transfer Protocol (HTTP) messaging. RCP program 748 performs the steps for RCP described in detail in the figures and description provided above, as well as Graphical User Interfaces (GUIs) used in the present invention.

Prior final capacity statements file 750 includes final capacity statements generated by previous iterations of the steps described above, and can be re-used in new iterations.

LoB files 752 include data specific for different lines of business which data may be input into process 102 described above with reference to FIG. 1.

The hardware elements depicted in TPA server 702 are not intended to be exhaustive, but rather are representative to highlight essential components required by the present invention. For instance, TPA server 702 may include alternate memory storage devices such as magnetic cassettes, Digital Versatile Disks (DVDs), Bernoulli cartridges, and the like. These and other variations are intended to be within the spirit and scope of the present invention.

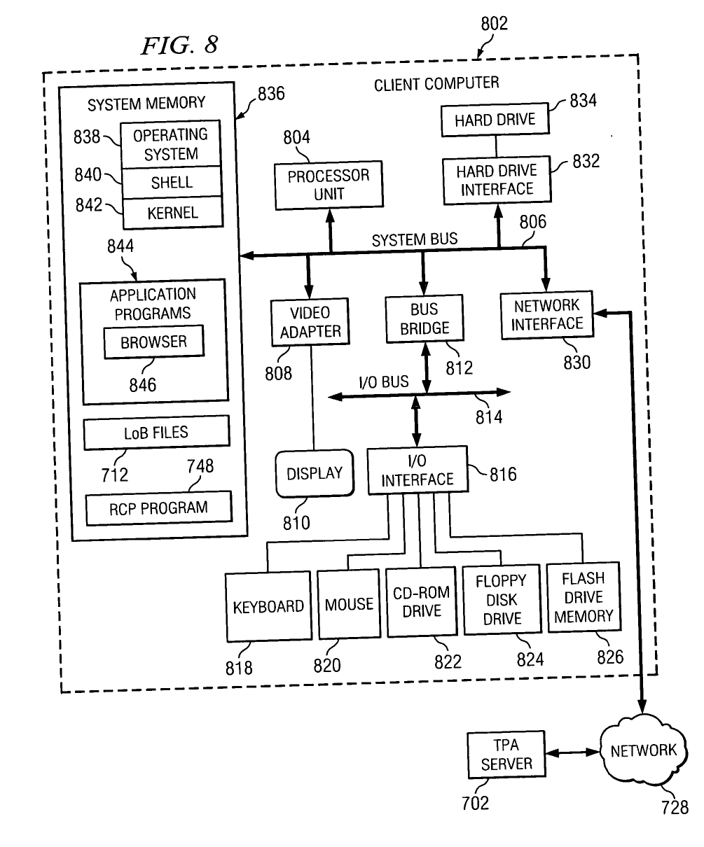

With reference now to FIG. 8, there is depicted a block diagram of an exemplary client computer 802, which is an exemplary computer for either a client of a third party administrator (service provider) or the service provider itself. Client computer 802 includes a processor unit 804 coupled to a system bus 806. Also coupled to system bus 806 is a video adapter 808, which drives/supports a display 810. System bus 806 is coupled via a bus bridge 812 to an Input/Output (I/O) bus 814. Coupled to I/O bus 814 is an I/O interface 816, which affords communication with various I/O devices, including a keyboard 818, a mouse 820, a Compact Disk—Read Only Memory (CD-ROM) drive 822, a floppy disk drive 824, and a flash drive memory 826. The format of the ports connected to I/O interface 816 may be any known to those skilled in the art of computer architecture, including but not limited to Universal Serial Bus (USB) ports.

Client computer 802 is able to communicate with TPA server 702 via network 728 using a network interface 830, which is coupled to system bus 806.

Also coupled to system bus 806 is a hard drive interface 832, which interfaces with a hard drive 834. In a preferred embodiment, hard drive 834 populates a system memory 836, which is also coupled to system bus 806. Data that populates system memory 836 includes client computer 802's operating system 838, which includes a shell 840 and a kernel 842, for providing transparent user access to resources such as application programs 844, which include a browser 846. Optionally, client computer 802's system memory 836 may include the RCP program 748 and LoB file 712 described above.

The hardware elements depicted in client computer 802 are not intended to be exhaustive, but rather are representative to highlight essential components required by the present invention. For instance, client computer 802 may include alternate memory storage devices such as magnetic cassettes, Digital Versatile Disks (DVDs), Bernoulli cartridges, and the like. These and other variations are intended to be within the spirit and scope of the present invention.

It should be understood that at least some aspects of the present invention may alternatively be implemented in a computer-readable medium that contains a program product. Programs defining functions on the present invention can be delivered to a data storage system or a computer system via a variety of signal-bearing media, which include, without limitation, non-writable storage media (e.g., CD-ROM), writable storage media (e.g., a floppy diskette, hard disk drive, read/write CD ROM, optical media), and communication media, such as computer and telephone networks including Ethernet. It should be understood, therefore in such signal-bearing media when carrying or encoding computer readable instructions that direct method functions in the present invention, represent alternative embodiments of the present invention. Further, it is understood that the present invention may be implemented by a system having means in the form of hardware, software, or a combination of software and hardware as described herein or their equivalent.

Software Deployment

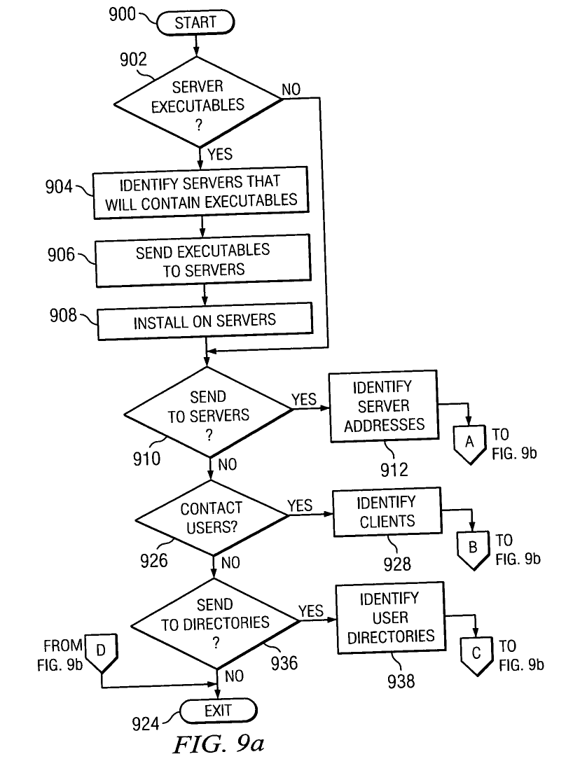

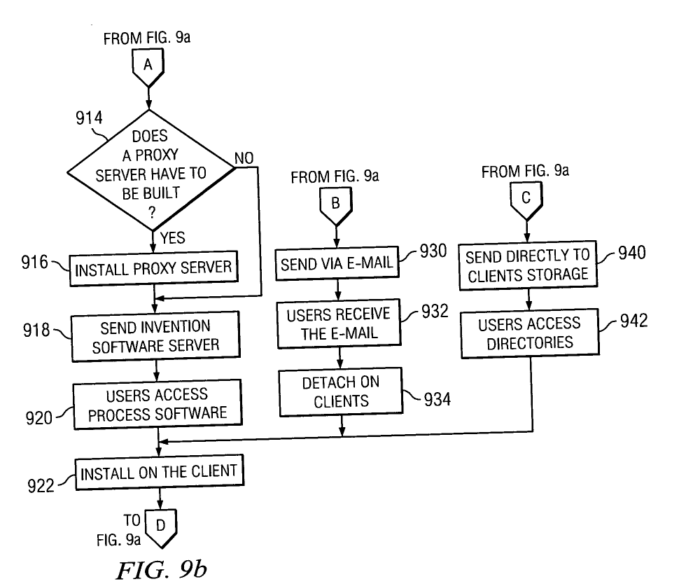

Thus, the method described herein, and in particular as shown in FIGS. 5 and 6a, can be deployed as a process software. Referring now to FIG. 9, step 900 begins the deployment of the process software. The first thing is to determine if there are any programs that will reside on a server or servers when the process software is executed (query block 902). If this is the case, then the servers that will contain the executables are identified (block 904). The process software for the server or servers is transferred directly to the servers' storage via File Transfer Protocol (FTP) or some other protocol or by copying though the use of a shared file system (block 906). The process software is then installed on the servers (block 908).

Next, a determination is made on whether the process software is be deployed by having users access the process software on a server or servers (query block 910). If the users are to access the process software on servers, then the server addresses that will store the process software are identified (block 912).

A determination is made if a proxy server is to be built (query block 914) to store the process software. A proxy server is a server that sits between a client application, such as a Web browser, and a real server. It intercepts all requests to the real server to see if it can fulfill the requests itself. If not, it forwards the request to the real server. The two primary benefits of a proxy server are to improve performance and to filter requests. If a proxy server is required, then the proxy server is installed (block 916). The process software is sent to the servers either via a protocol such as FTP or it is copied directly from the source files to the server files via file sharing (block 918). Another embodiment would be to send a transaction to the servers that contained the process software and have the server process the transaction, then receive and copy the process software to the server's file system. Once the process software is stored at the servers, the users via their client computers, then access the process software on the servers and copy to their client computers file systems (block 920). Another embodiment is to have the servers automatically copy the process software to each client and then run the installation program for the process software at each client computer. The user executes the program that installs the process software on his client computer (block 922) then exits the process (terminator block 924).

In query step 926, a determination is made whether the process software is to be deployed by sending the process software to users via e-mail. The set of users where the process software will be deployed are identified together with the addresses of the user client computers (block 928). The process software is sent via e-mail to each of the users' client computers (block 930). The users then receive the e-mail (block 932) and then detach the process software from the e-mail to a directory on their client computers (block 934). The user executes the program that installs the process software on his client computer (block 922) then exits the process (terminator block 924).

Lastly a determination is made on whether to the process software will be sent directly to user directories on their client computers (query block 936). If so, the user directories are identified (block 938). The process software is transferred directly to the user's client computer directory (block 940). This can be done in several ways such as but not limited to sharing of the file system directories and then copying from the sender's file system to the recipient user's file system or alternatively using a transfer protocol such as File Transfer Protocol (FTP). The users access the directories on their client file systems in preparation for installing the process software (block 942). The user executes the program that installs the process software on his client computer (block 922) and then exits the process (terminator block 924).

VPN Deployment

The present software can be deployed to third parties as part of a service wherein a third party VPN service is offered as a secure deployment vehicle or wherein a VPN is build on-demand as required for a specific deployment.

A virtual private network (VPN) is any combination of technologies that can be used to secure a connection through an otherwise unsecured or untrusted network. VPNs improve security and reduce operational costs. The VPN makes use of a public network, usually the Internet, to connect remote sites or users together. Instead of using a dedicated, real-world connection such as leased line, the VPN uses “virtual” connections routed through the Internet from the company's private network to the remote site or employee. Access to the software via a VPN can be provided as a service by specifically constructing the VPN for purposes of delivery or execution of the process software (i.e. the software resides elsewhere) wherein the lifetime of the VPN is limited to a given period of time or a given number of deployments based on an amount paid.

The process software may be deployed, accessed and executed through either a remote-access or a site-to-site VPN. When using the remote-access VPNs the process software is deployed, accessed and executed via the secure, encrypted connections between a company's private network and remote users through a third-party service provider. The enterprise service provider (ESP) sets a network access server (NAS) and provides the remote users with desktop client software for their computers. The telecommuters can then dial a toll-free number or attach directly via a cable or DSL modem to reach the NAS and use their VPN client software to access the corporate network and to access, download and execute the process software.

When using the site-to-site VPN, the process software is deployed, accessed and executed through the use of dedicated equipment and large-scale encryption that are used to connect a companies multiple fixed sites over a public network such as the Internet.

The process software is transported over the VPN via tunneling which is the process the of placing an entire packet within another packet and sending it over a network. The protocol of the outer packet is understood by the network and both points, called tunnel interfaces, where the packet enters and exits the network.

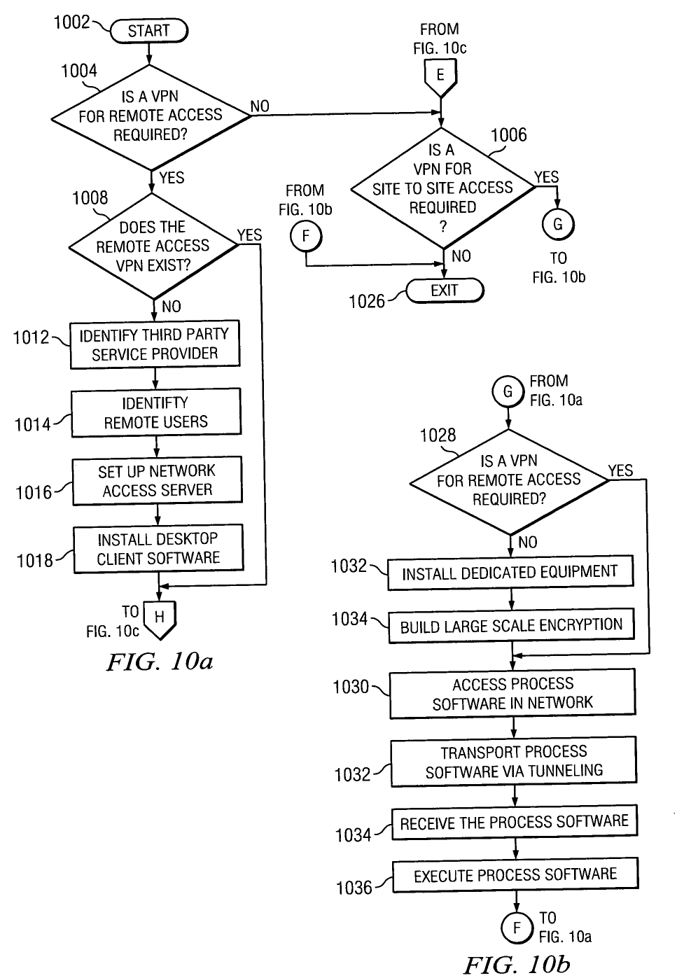

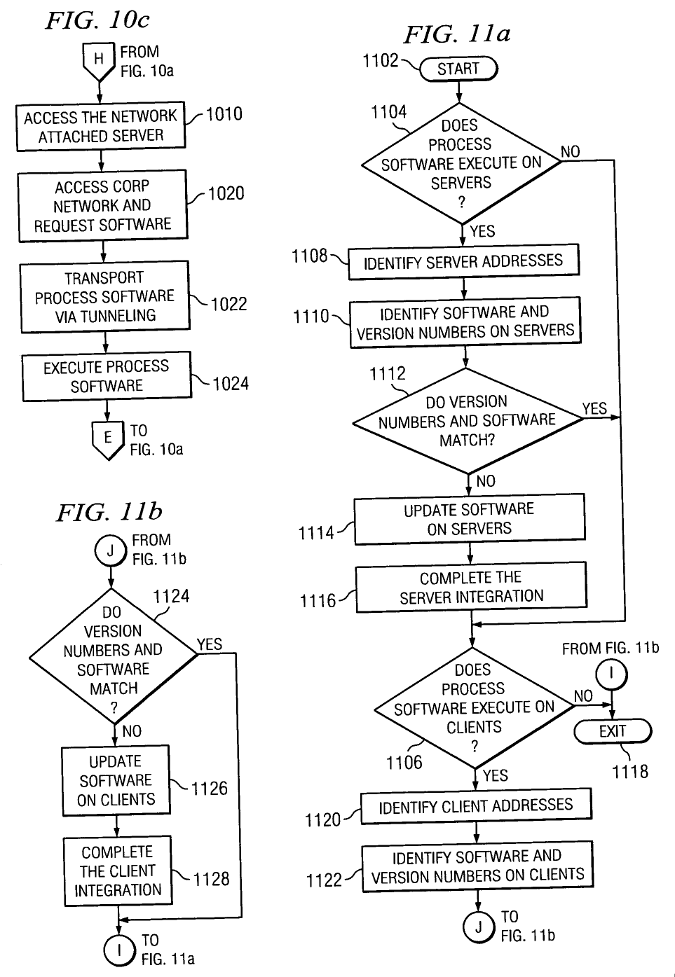

The process for such VPN deployment is described in FIG. 10. Initiator block 1002 begins the Virtual Private Network (VPN) process. A determination is made to see if a VPN for remote access is required (query block 1004). If it is not required, then proceed to (query block 1006). If it is required, then determine if the remote access VPN exists (query block 1008).

If a VPN does exist, then proceed to block 1010. Otherwise identify a third party provider that will provide the secure, encrypted connections between the company's private network and the company's remote users (block 1012). The company's remote users are identified (block 1014). The third party provider then sets up a network access server (NAS) (block 1016) that allows the remote users to dial a toll free number or attach directly via a broadband modem to access, download and install the desktop client software for the remote-access VPN (block 1018).

After the remote access VPN has been built or if it been previously installed, the remote users can access the process software by dialing into the NAS or attaching directly via a cable or DSL modem into the NAS (block 1010). This allows entry into the corporate network where the process software is accessed (block 1020). The process software is transported to the remote user's desktop over the network via tunneling. That is the process software is divided into packets and each packet including the data and protocol is placed within another packet (block 1022). When the process software arrives at the remote user's desktop, it is removed from the packets, reconstituted and then is executed on the remote users desktop (block 1024).

A determination is then made to see if a VPN for site to site access is required (query block 1006). If it is not required, then proceed to exit the process (terminator block 1026). Otherwise, determine if the site to site VPN exists (query block 1028). If it does exist, then proceed to block 1030. Otherwise, install the dedicated equipment required to establish a site to site VPN (block 1032). Then build the large scale encryption into the VPN (block 1034).

After the site to site VPN has been built or if it had been previously established, the users access the process software via the VPN (block 1030). The process software is transported to the site users over the network via tunneling (block 1032). That is the process software is divided into packets and each packet including the data and protocol is placed within another packet (block 1034). When the process software arrives at the remote user's desktop, it is removed from the packets, reconstituted and is executed on the site users desktop (block 1036). The process then ends at terminator block 1026.

Software Integration

The process software which consists code for implementing the process described herein may be integrated into a client, server and network environment by providing for the process software to coexist with applications, operating systems and network operating systems software and then installing the process software on the clients and servers in the environment where the process software will function.

The first step is to identify any software on the clients and servers including the network operating system where the process software will be deployed that are required by the process software or that work in conjunction with the process software. This includes the network operating system that is software that enhances a basic operating system by adding networking features.

Next, the software applications and version numbers will be identified and compared to the list of software applications and version numbers that have been tested to work with the process software. Those software applications that are missing or that do not match the correct version will be upgraded with the correct version numbers. Program instructions that pass parameters from the process software to the software applications will be checked to ensure the parameter lists matches the parameter lists required by the process software. Conversely parameters passed by the software applications to the process software will be checked to ensure the parameters match the parameters required by the process software. The client and server operating systems including the network operating systems will be identified and compared to the list of operating systems, version numbers and network software that have been tested to work with the process software. Those operating systems, version numbers and network software that do not match the list of tested operating systems and version numbers will be upgraded on the clients and servers to the required level.

After ensuring that the software, where the process software is to be deployed, is at the correct version level that has been tested to work with the process software, the integration is completed by installing the process software on the clients and servers.

For a high-level description of this process, reference is now made to FIG. 11. Initiator block 1102 begins the integration of the process software. The first thing is to determine if there are any process software programs that will execute on a server or servers (block 1104). If this is not the case, then integration proceeds to query block 1106. If this is the case, then the server addresses are identified (block 1108). The servers are checked to see if they contain software that includes the operating system (OS), applications, and network operating systems (NOS), together with their version numbers, which have been tested with the process software (block 1110). The servers are also checked to determine if there is any missing software that is required by the process software in block 1110.

A determination is made if the version numbers match the version numbers of OS, applications and NOS that have been tested with the process software (block 1112). If all of the versions match and there is no missing required software the integration continues in query block 1106.

If one or more of the version numbers do not match, then the unmatched versions are updated on the server or servers with the correct versions (block 1114). Additionally if there is missing required software, then it is updated on the server or servers in the step shown in block 1114. The server integration is completed by installing the process software (block 1116).

The step shown in query block 1106, which follows either the steps shown in block 1104, 1112 or 1116 determines if there are any programs of the process software that will execute on the clients. If no process software programs execute on the clients the integration proceeds to terminator block 1118 and exits. If this not the case, then the client addresses are identified as shown in block 1120.

The clients are checked to see if they contain software that includes the operating system (OS), applications, and network operating systems (NOS), together with their version numbers, which have been tested with the process software (block 1122). The clients are also checked to determine if there is any missing software that is required by the process software in the step described by block 1122.

A determination is made is the version numbers match the version numbers of OS, applications and NOS that have been tested with the process software (query block 1124). If all of the versions match and there is no missing required software, then the integration proceeds to terminator block 1118 and exits.

If one or more of the version numbers do not match, then the unmatched versions are updated on the clients with the correct versions (block 1126). In addition, if there is missing required software then it is updated on the clients (also block 1126). The client integration is completed by installing the process software on the clients (block 1128). The integration proceeds to terminator block 1118 and exits.

On Demand

The process software is shared, simultaneously serving multiple customers in a flexible, automated fashion. It is standardized, requiring little customization and it is scalable, providing capacity on demand in a pay-as-you-go model.

The process software can be stored on a shared file system accessible from one or more servers. The process software is executed via transactions that contain data and server processing requests that use CPU units on the accessed server. CPU units are units of time such as minutes, seconds, hours on the central processor of the server. Additionally the assessed server may make requests of other servers that require CPU units. CPU units are an example that represents but one measurement of use. Other measurements of use include but are not limited to network bandwidth, memory usage, storage usage, packet transfers, complete transactions etc.

When multiple customers use the same process software application, their transactions are differentiated by the parameters included in the transactions that identify the unique customer and the type of service for that customer. All of the CPU units and other measurements of use that are used for the services for each customer are recorded. When the number of transactions to any one server reaches a number that begins to affect the performance of that server, other servers are accessed to increase the capacity and to share the workload. Likewise when other measurements of use such as network bandwidth, memory usage, storage usage, etc. approach a capacity so as to affect performance, additional network bandwidth, memory usage, storage etc. are added to share the workload.

The measurements of use used for each service and customer are sent to a collecting server that sums the measurements of use for each customer for each service that was processed anywhere in the network of servers that provide the shared execution of the process software. The summed measurements of use units are periodically multiplied by unit costs and the resulting total process software application service costs are alternatively sent to the customer and or indicated on a web site accessed by the customer which then remits payment to the service provider.

In another embodiment, the service provider requests payment directly from a customer account at a banking or financial institution.

In another embodiment, if the service provider is also a customer of the customer that uses the process software application, the payment owed to the service provider is reconciled to the payment owed by the service provider to minimize the transfer of payments.

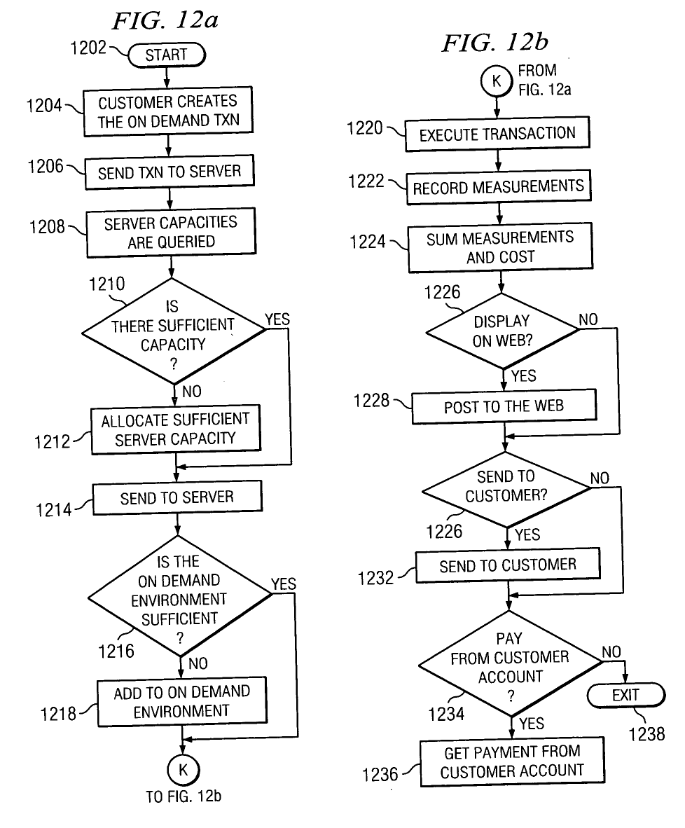

With reference now to FIG. 12, initiator block 1202 begins the On Demand process. A transaction is created than contains the unique customer identification, the requested service type and any service parameters that further specify the type of service (block 1204). The transaction is then sent to the main server (block 1206). In an On Demand environment the main server can initially be the only server, then as capacity is consumed other servers are added to the On Demand environment.

The server central processing unit (CPU) capacities in the On Demand environment are queried (block 1208). The CPU requirement of the transaction is estimated, then the servers available CPU capacity in the On Demand environment are compared to the transaction CPU requirement to see if there is sufficient CPU available capacity in any server to process the transaction (query block 1210). If there is not sufficient server CPU available capacity, then additional server CPU capacity is allocated to process the transaction (block 1212). If there was already sufficient Available CPU capacity then the transaction is sent to a selected server (block 1214).

Before executing the transaction, a check is made of the remaining On Demand environment to determine if the environment has sufficient available capacity for processing the transaction. This environment capacity consists of such things as but not limited to network bandwidth, processor memory, storage etc. (block 1216). If there is not sufficient available capacity, then capacity will be added to the On Demand environment (block 1218). Next the required software to process the transaction is accessed, loaded into memory, then the transaction is executed (block 1220).

The usage measurements are recorded (block 1222). The usage measurements consist of the portions of those functions in the On Demand environment that are used to process the transaction. The usage of such functions as, but not limited to, network bandwidth, processor memory, storage and CPU cycles are what is recorded. The usage measurements are summed, multiplied by unit costs and then recorded as a charge to the requesting customer (block 1224).

If the customer has requested that the On Demand costs be posted to a web site (query block 1226), then they are posted (block 1228). If the customer has requested that the On Demand costs be sent via e-mail to a customer address (query block 1230), then these costs are sent to the customer (block 1232). If the customer has requested that the On Demand costs be paid directly from a customer account (query block 1234), then payment is received directly from the customer account (block 1236). The On Demand process is then exited at terminator block 1238.

While the invention has been particularly shown and described with reference to a preferred embodiment, it will be understood by those skilled in the art that various changes in form and detail may be made therein without departing from the spirit and scope of the invention.

What is claimed is:

1. A method comprising:
identifying future resource requirements as determined by ongoing work engagements, future planned work projects, and future proposed work projects;
creating a demand plan based on the future resource requirements;
creating a supply statement that is determined by a predicted future resource supply;
comparing the supply statement with the demand plan to conduct and develop a preliminary capacity statement;
preparing a resource plan to mitigate excesses and shortages of labor as described by the preliminary capacity statement;
specifying resource actions in a tactical time frame to reduce gaps in sources of future laborers;
creating a final capacity statement based on an execution of the resource actions;
tracking an accuracy of the final capacity statement based on a success of a job project in being supplied with a proper quantity of qualified workers; and
modifying the demand plan, resource plan, preliminary capacity statement, and final capacity statement according to the accuracy of the final capacity statement.

2. The method of claim 1, wherein the resource actions are specified at a plurality of tactical time frames.

3. The method of claim 2, wherein a first time frame from the tactical time frames is set at a first time frame that is prior to the job project, wherein the first time frame affords adequate time to locate and hire workers for the job project.

4. The method of claim 3, wherein a second time frame from the tactical time frames is set at a second time frame that is prior to the first time frame, wherein the second time frame affords adequate time to train workers for the job project.

5. The method of claim 4, wherein a second time frame from the tactical time frames is set at a third time frame that is prior to the second time frame, wherein the third time frame affords adequate time to establish guidelines and rules for the steps taken in the second and first time frames.

6. The method of claim 1, wherein the steps described in claim 1 are applicable to any enterprise.

7. The method of claim 6, wherein the future resource requirements are determined by a prior job's track and measurement execution of a final capacity statement, historical data from other jobs, confirmed job projects, proposed job projects, and an enterprise-defined function.

8. The method of claim 7, wherein the enterprise-defined function includes, for a particular line of business, a business strategy, revenue targets, labor utilization targets, current labor utilization, and pipelined projects.

9. The method of claim 8, wherein the enterprise-defined function is for a single enterprise.

10. The method of claim 1, wherein labor is supplied both by resources within an enterprise as well as by labor sources outside the enterprise.

11. The method of claim 1, wherein the steps taken in claim 1 are limited to a specific geographical region.

12. The method of claim 1, further comprising:
determining whether to initiate or abandon the job project based on the final capacity statement.

13. The method of claim 1, further comprising:
re-using the future resource requirements and the supply statement to generate a final capacity statement for a new job project.

14. A machine-readable medium having a plurality of instructions processable, by a machine embodied therein, wherein said plurality of instructions, when processed by said machine causes said machine to perform a method comprising:
identifying future resource requirements as determined by ongoing work engagements, future planned work projects, and future proposed work projects;
creating a demand plan based on the future resource requirements;
creating a supply statement that is determined by a predicted future resource supply;
comparing the supply statement with the demand plan to conduct and develop a preliminary capacity statement;
preparing a resource plan to mitigate excesses and shortages of labor as described by the preliminary capacity statement;
specifying resource actions in a tactical time frame to reduce gaps in sources of future laborers;
creating a final capacity statement based on an execution of the resource actions;
tracking an accuracy of the final capacity statement based on a success of a job project in being supplied with a proper quantity of qualified workers; and
modifying the demand plan, resource plan, preliminary capacity statement, and final capacity statement according to the accuracy of the final capacity statement.

15. The machine-readable medium of claim 14, wherein the steps in the method described in claim 14 are applicable to any enterprise.

16. The machine-readable medium of claim 15, wherein the future resource requirements are determined by a prior job's track and measurement execution of a final capacity statement, historical data from other jobs, confirmed job projects, proposed job projects, and a line-of-business defined function, and wherein the enterprise-defined function includes, for a particular line of business, a business strategy, revenue targets, labor utilization targets, current labor utilization, and pipelined projects.

17. The machine-readable medium of claim 14, wherein the method further comprises:
determining whether to initiate or abandon the job project based on the final capacity statement.

18. The machine-readable medium of claim 14, wherein the resource actions in the method are specified at a plurality of tactical time frames.

19. The machine-readable medium of claim 15, wherein the processable instructions are deployed to a server from a remote location.

20. The machine-readable medium of claim 15, wherein the processable instructions are provided by a service provider to a customer on an on-demand basis.
